(19) United States
(12) Patent Application Publication
(10) Pub. No.: US 2015/0004423 A1
(43) Pub. Date: Jan. 1, 2015

(54) RESINS AND RADOMES INCLUDING THEM

(71) Applicant: Saint-Gobain Performance Plastics Corporation, Aurora, OH (US)

(72) Inventors: Kapsoo Cheon, Shrewsbury, MA (US); Ajay Padwal, Shrewsbury, MA (US)

(21) Appl. No.: 14/314,062

(22) Filed: Jun. 25, 2014

Related U.S. Application Data
(60) Provisional application No. 61/840,894, filed on Jun. 28, 2013.

(51) Int. Cl. H01Q 1/42; C08F 232/08; C08F 32/08

(52) U.S. Cl. CPC H01Q 1/42; C08F 32/08; C08F 232/08
USPC 428/521; 526/283; 526/282

(57) ABSTRACT

Certain embodiments are directed to resins comprising norbornene derivatives for use in structures such as radomes. In some examples, the radome comprises a dielectric constant of less than 2.7, a loss tangent of less than 0.003 and a moisture absorption of less than 1.5%.

### TECHNOLOGICAL FIELD

This application is related to resins. More particularly, certain embodiments described herein are directed to cyclically strained alkenes that are effective to undergo ring opening metathesis polymerization and provide a resin with suitable physical properties for use in articles such as, for example, radomes.

### BACKGROUND

A radome is a structure that encloses and protects an antenna. The structure is generally weatherproof and protects the underlying antenna from the elements, from being contacted by personnel or from damage from external factors such as wind or temperature.

### SUMMARY

In some aspects, a radome comprising a plurality of plies coupled to each other, in which at least one of the plurality of plies comprises a substrate and a resin produced from a cyclically strained alkene effective to undergo ring opening metathesis polymerization in the presence of a catalyst to provide the resin, in which the radome comprises a dielectric constant of less than 2.7, a loss tangent of less than 0.003 and a moisture absorption of less than 1.5% is provided. In some embodiments, the radome may cover an separate and non-integral electronic device to protect the electronic device from weather or external contact.

In certain instances, the radome comprises a dielectric constant of less than 2.7, a loss tangent of less than 0.003 and a moisture absorption of less than 1%. In other configurations, the radome comprises a dielectric constant of less than 2.6, a loss tangent of less than 0.0025 and a moisture absorption of less than 1%.

In some embodiments, the cyclically strained alkene of the resin is a compound of formula (I)

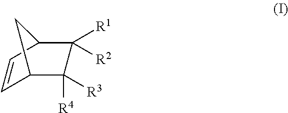

in which R¹, R², R³ and R⁴ of formula (I) may each independently be hydrogen or a hydrocarbon group comprising 1 to 10 carbon atoms, a hydrocarbon group comprising 1 to 6 carbon atoms or each of R¹, R², R³ and R⁴ of formula (I) may be hydrogen.

In some configurations, the cyclically strained alkene of the radome is a compound of formula (II)

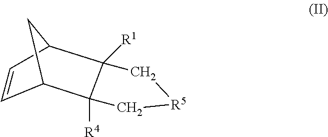

in which R¹ and R⁴ of formula (II) may each independently be hydrogen or a hydrocarbon group comprising 1 to 10 carbon atoms, e.g., 1 to 6 carbon atoms, and R⁵ may be —CH₂, oxygen, a secondary amine or a tertiary amine. In some instances, each of R¹ and R⁴ of formula (II) is hydrogen and R⁵ is —CH₂.

In certain examples, the cyclically strained alkene of the radome is a compound of formula (III)

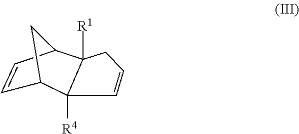

in which R¹ and R⁴ of formula (III) may each independently be hydrogen or a hydrocarbon group comprising 1 to 10 carbon atoms, e.g., a hydrocarbon group comprising 1 to 6 carbon atoms or a halohydrocarbon group comprising 1 to 6 carbon atoms. In some embodiments, each of R¹ and R⁴ of formula (III) is hydrogen.

In certain embodiments, the resin of the radome may comprise two different cyclically strained alkenes each effective to undergo ring opening metathesis polymerization in the presence of a catalyst to provide the resin. In some instances, one of the cyclically strained alkenes is a norbornene derivative and the other cyclically strained alkene is dicyclopentadiene. In other instances, one of the cyclically strained alkenes is a 5-ethylene-2-norbornene and the other cyclically strained alkene is dicyclopentadiene. In further examples, the cyclically strained alkene is effective to polymerize by ring opening metathesis polymerization in the presence of a catalyst to provide a bi-curable resin comprising a dielectric constant of less than 2.7, a loss tangent of less than 0.003 and a moisture absorption of less than 1.5%. In certain examples, the cyclically strained alkene is a dicylopentadiene and the substrate comprises fiberglass comprising quartz. In some embodiments, the cyclically strained alkene is a norbornene derivative and the substrate comprises fiberglass comprising quartz. In certain embodiments, one of the cyclically strained alkenes is dicylopentadiene and the other cyclically strained alkene is a norbornene derivative and the substrate comprises fiberglass comprising quartz.

In another aspect, a prepreg comprising a plurality of plies coupled to each other, in which at least one of the plurality of plies comprises a substrate and a cyclically strained alkene effective to polymerize by ring opening metathesis polymerization in the presence of a catalyst to provide a resin, in which the resin comprises a dielectric constant of less than 2.7, a loss tangent of less than 0.003 and a moisture absorption of less than 1.5% is disclosed.

In certain embodiments, the resin of the prepreg comprises a dielectric constant of less than 2.6, a loss tangent of less than 0.003 and a moisture absorption of less than 1%. In some examples, the resin of the prepreg comprises a dielectric constant of less than 2.4, a loss tangent of less than 0.0015 and a moisture absorption of less than 1%.

In other embodiments, the cyclically strained alkene of the prepreg is a compound of formula (I)

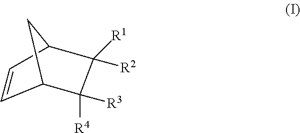

in which R¹, R², R³ and R⁴ of formula (I) may each independently be hydrogen or a hydrocarbon group comprising 1 to 10 carbon atoms, e.g., 1-6 carbon atoms. In certain examples, each of R¹, R², R³ and R⁴ of formula (I) is hydrogen.

In additional instances, the cyclically strained alkene of the prepreg is a compound of formula (II)

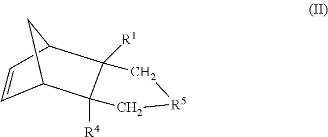

in which R¹ and R⁴ of formula (II) may each independently be hydrogen or a hydrocarbon group comprising 1 to 10 carbon atoms, e.g., 1-6 carbon atoms, and R⁵ may be —CH₂, oxygen, a secondary amine or a tertiary amine. In some embodiments, each of R¹ and R⁴ of formula (II) is hydrogen and R⁵ is —CH₂.

In certain embodiments, the cyclically strained alkene of the prepreg is a compound of formula (III)

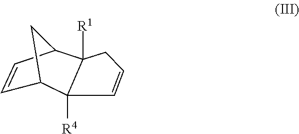

in which R¹ and R⁴ of formula (III) may each independently be hydrogen or a hydrocarbon group comprising 1 to 10 carbon atoms, e.g. a hydrocarbon group comprising 1-6 carbon atoms or a halohydrocarbon group comprising 1-6 carbon atoms. In some embodiments, each of R¹ and R⁴ of formula (III) is hydrogen. In some embodiments, one of R¹ and R⁴ is a halohydrocarbon group comprising 1 to 6 carbon atoms.

In certain examples, the resin of the prepreg comprises two different cyclically strained alkenes each effective to undergo ring opening metathesis polymerization in the presence of a catalyst to provide the resin. In some examples, one of the cyclically strained alkenes of the prepreg is a norbornene derivative and the other cyclically strained alkene is dicyclopentadiene. In other examples, one of the cyclically strained alkenes of the prepreg is a 5-ethylene-2-norbornene and the other cyclically strained alkene is dicyclopentadiene. In additional examples, the cyclically strained alkene of the prepreg is effective to polymerize by ring opening metathesis polymerization in the presence of a catalyst to provide a bi-curable resin comprising a dielectric constant of less than 2.7, a loss tangent of less than 0.003 and a moisture absorption of less than 1.5%. In other instances, the cyclically strained alkene of the prepreg is a dicylopentadiene and the substrate comprises fiberglass comprising quartz. In other examples, the cyclically strained alkene of the prepreg is a norbornene derivative and the substrate comprises fiberglass comprising quartz. In some embodiments, one of the cyclically strained alkenes of the prepreg is dicylopentadiene and the other cyclically strained alkene of the prepreg is a norbornene derivative and the substrate comprises fiberglass comprising quartz.

In an additional aspect, a resin comprising a cyclically strained alkene effective to undergo ring opening metathesis polymerization in the presence of a catalyst to provide a polymeric resin with a dielectric constant of less than 2.7, a loss tangent of less than 0.003 and a moisture absorption of less than 1.5% is provided. If desired, the resin may comprise two more cyclically strained alkenes each effective to undergo ring opening metathesis polymerization in the presence of a catalyst to provide a polymeric resin with a dielectric constant of less than 2.7, a loss tangent of less than 0.003 and a moisture absorption of less than 1.5%

In certain embodiments, the cyclically strained alkene of the resin is a compound of formula (I)

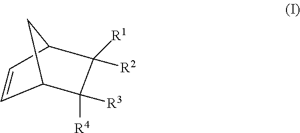

in which R¹, R², R³ and R⁴ of formula (I) may each independently be hydrogen or a hydrocarbon group comprising 1 to 10 carbon atoms, e.g., 1-6 carbon atoms. In some embodiments, each of R¹, R², R³ and R⁴ of formula (I) is hydrogen.

In additional embodiments, the cyclically strained alkene of the resin is a compound of formula (II)

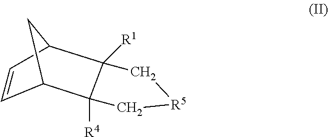

in which R¹ and R⁴ of formula (II) may each independently be hydrogen or a hydrocarbon group comprising 1 to 10 carbon atoms, e.g., 1-6 carbon atoms and R⁵ may be —CH₂, oxygen, a secondary amine or a tertiary amine. In some embodiments, each of R¹ and R⁴ of formula (II) is hydrogen and R⁵ is —CH₂.

In other examples, the cyclically strained alkene of the resin is a compound of formula (III)

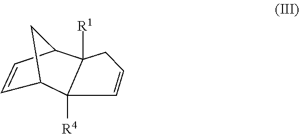

in which R¹ and R⁴ of formula (III) may each independently be hydrogen or a hydrocarbon group comprising 1 to 10 carbon atoms, e.g., a hydrocarbon group comprising 1 to 6 carbon atoms or a halohydrocarbon group comprising 1 to 6 carbon atoms.

In some instances, the cyclically strained alkene is dicyclopentadiene. Where two cyclically strained alkenes are present in the resin, one of the cyclically strained alkenes is a norbornene derivative, e.g., an ethylene norbornene derivative, and the other cyclically strained alkene is dicyclopentadiene.

In some aspects, a system comprising the radomes described herein may comprise a radome and an electronic device covered by the radome. The exact nature of the electronic device may vary and illustrative electronic devices are described herein. In some embodiments, the electronic device comprises an antenna and/or a transmitter/receiver that is configured to transmit and/or receive waves of a desired or selected frequency. In certain embodiments, the radome is sized and arranged to be placed on an aircraft. In other embodiments, the radome is sized and arranged to be placed on a ship, e.g., on a non-immersed surface of a ship or on an immersed surface of a ship. In some examples, the electronic device may be part of a radar system, a sonar system, or a communication system. For example, the communication system may be a Wi-Fi system, a Bluetooth system, a radio communication system and a satellite system. In other instances, the radome may be present in an automotive vehicle, an aircraft, e.g., an aircraft comprising a radar system covered by the radome, or a submarine, e.g., a submarine comprising a sonar system covered by the radome.

In some embodiments, a method of producing a radome comprising disposing one or more of the resins described herein on a substrate, and polymerizing the disposed resin to provide a radome comprising a dielectric constant of less than 2.7, a loss tangent of less than 0.003 and a moisture absorption of less than 1.5% is provided. In some embodiments, the polymerizing step comprises permitting the resin to polymerize by ring opening metathesis polymerization at a first temperature for a first period and then completing polymerization of the resin at a second temperature, higher than the first temperature, for a second period. In certain instances, the method further comprises adding at least one additive to the resin before or after polymerization of the resin, e.g., adding anti-oxidants, such as organophosphites (e.g. tris(nonyl-phenyl)phosphite, tris(2,4-di-t-butylphenyl)phosphite); hindered phenols (e.g. 2,6-di-t-butyl-4-methylphenol, 4,4′-methylenebis(2,6-di-tertiary-butylphenol), tougheners such as elastomers (e.g. polybutadiene, polyisoprene), block copolymers (e.g. styrene-butadiene-styrene), polysiloxanes, flame retardants such as brominated agents (e.g. tetrabromobisphenol), phosphorous agents (e.g. bisphenol diphenyl phosphate, bisphenol A bis(diphenylphosphate)), inorganic agents (e.g. Al₂O₃), adhesion promoters to improve adhesion between the resin and the fabrics, such as polar group containing olefins (e.g. norbornene esters), a smoke suppressant, a pigment or other materials as described herein.

Additional features, aspect, examples and embodiments are described in more detail below.

### BRIEF DESCRIPTION OF THE FIGURES

Certain embodiments are described with reference to the accompanying figures in which:

FIG. 1 is an illustration of a prepreg comprising a plurality of plies;

FIG. 2 is another illustration of a prepreg comprising a plurality of plies where two of the plies comprise different materials;

FIG. 3 is an illustration of a prepreg comprising a protective layer;

FIG. 4 is an illustration of a radome comprising an antenna; and

FIG. 5 is an illustration of a radome covering an electronic device.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. Reference to front, back, top and bottom are provided for exemplary purposes and are not limiting.

### DETAILED DESCRIPTION

Certain embodiments are described below with reference to singular and plural terms in order to provide a user friendly description of the technology disclosed herein. These terms are used for convenience purposes only and are not intended to limit the materials and structures described herein as including or excluding certain features unless otherwise noted as being present in a particular embodiment described herein.

In certain configurations, the radomes described herein generally comprise a substrate with a resin impregnated, added to or otherwise present in or on the substrate. The substrate may be produced by disposing a plurality of individual plies or layers on each other and coupling the plies together and/or molding or forming the plies to a desired shape to provide an article with desirable physical properties, e.g., to permit use of the article as a radome that may comprise one or more of the following attributes: (1) a dielectric constant at 10 GHz (or other selected frequency, e.g., 1 MHz, 10 MHz, etc., that can be measured using ASTM 2520 of less than or equal to 2.7, more particularly a dielectric constant of less than or equal to 2.6, 2.5 or even 2.4, (2) a loss tangent (as measured by ASTM 2520) of less than or equal 0.003, more particularly, less than or equal to 0.00275, 0.0025 or even less than or equal to 0.00225, and (3) water (moisture) absorption (as measured by ASTM D570-98) of less than or equal to 1.5%, more particularly, less than or equal to 1.4%, 1.3%, 1.25%, 1.1%, 1% or even less than or equal to 0.75%. The resins described herein are generally considered thermoset or thermosetting resins so the cured article can withstand environmental conditions commonly encountered by radomes, though in certain instances one or more thermoplastic materials may be present in certain areas, layers or parts of the articles. Unless otherwise specified, reference to dielectric constant and loss tangent in the description below and the claims appended hereto refer to values obtained using the ASTM 2520 test noted above. While described more specifically in the ASTM 2520 protocol, the dielectric strength was generally measured using cavity perturbation methods and a rectangular waveguide. The sample is placed between plates of the waveguide to measure the dielectric properties. Similarly, reference to moisture or water absorption values refer to those values obtained using ASTM D570-98. While described more specifically in the ASTM D570-98 protocol, the moisture absorption was generally measured by drying disk specimens in an oven for a specified time and temperature and then placing them in a desiccator to cool. Immediately upon cooling the specimens are weighed. The material is then emerged in water at a specified temperature, e.g., 23° C. for 24 hours or until equilibrium. Specimens are removed, patted dry with a lint free cloth, and weighed to determine the amount of water absorbed. Glass transition temperature may also be measured by suitable ASTM tests such as, for example, ASTM D3418-03.

In certain examples, the resins described herein may be produced from any monomer which is effective to polymerize by way of ring opening metathesis polymerization (ROMP). For example, suitable materials may include one more cyclically strained monomers comprising one or more areas of unsaturation. The monomer may include one or more strained rings or cyclic structures to favor the ROMP pathway over other potential pathways. For example, cyclically constrained alkenes comprising one, two, three or more sites of unsaturation may be used. Relief of ring strain in the cyclically strained alkene monomers by way of ROMP can relieve the ring strain and result in polymerization of the reactants. In certain embodiments described herein, the resin may be produced using monomeric reactants that comprise bicyclic and tricyclic compounds that comprise ring strain. Illustrative general compounds and specific compounds are described in more detail below.

In some examples, to facilitate ROMP one or more catalysts may be present. Without wishing to be bound by any particular scientific theory, the catalyst may generally be effective to promote formation of a metal-carbene intermediate, a hydride intermediate or other suitable intermediates depending on the catalyst and reactants used. Where metal-carbene intermediates form, the carbene can attack the double bond of the ring structure to form a metallocyclobutane intermediate, which has high ring strain that forces opening of the ring to provide an unsaturated monomer bonded to the catalyst. The resulting monomer comprises a terminal site of unsaturation that is effective as a reaction center to react with additional species of monomer. This reaction may continue to increase the monomeric units present in the chain and provide the polymeric species. The exact nature of the catalyst selected may depend on the particular reactants used. For example, substituted cyclically strained compounds may have groups that can poison the catalyst and terminate the polymerization. Illustrative catalysts include, but are not limited to, transition metal chlorides/alcohol mixtures (e.g., RuCl₃/alcohol), Grubb's catalysts (transitions metal carbene complexes such as PhCH═RuCl₂[P(Cy)₃)₂], (H₂IMes)(PCy3)(Cl)₂Ru═CHPh and osmium), Schrock catalysts (tungsten and molybdenum) and other metal catalysts.

In some embodiments, the reactants used to produce the resin may comprise norbornene or a norbornene derivative. For example, the reactant may comprise a compound of formula (I)

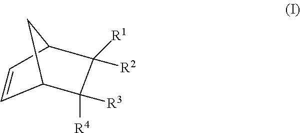

where R¹, R², R³ and R⁴ may each independently be hydrogen or a hydrocarbon group (saturated or unsaturated and linear or cyclic) comprising 1 to 10 carbon atoms. In some embodiments, each of R¹, R², R³ and R⁴ is independently hydrogen or a hydrocarbon group (saturated or unsaturated and linear or cyclic) comprising 1 to 6 carbon atoms. In other embodiments, each of R¹, R², R³ and R⁴ is independently hydrogen or a hydrocarbon group comprising 1 to 4 carbon atoms. In additional embodiments, each of R¹, R², R³ and R⁴ is independently hydrogen or a hydrocarbon group comprising 1 to 3 carbon atoms (saturated or unsaturated). In some embodiments, each of R¹, R², R³ and R⁴ is independently hydrogen or a hydrocarbon group (saturated or unsaturated) comprising 1 or 2 carbon atoms. In further embodiments, each of R¹, R², R³ and R⁴ is independently hydrogen and a methyl group. In some examples, each of R¹, R², R³ and R⁴ is hydrogen. In some embodiments, R² and R³ may together form a cyclic structure as shown in Formula (II)

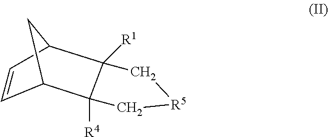

where R¹ and R⁴ may be any of those groups listed above in connection with Formula (I) and R⁵ may be —CH₂, oxygen, a secondary amine or a tertiary amine.

In certain embodiments, R¹, R², R³ and R⁴ of formula (I) and R¹ and R⁴ of formula (II) may each independently be —(CH₂)ₙCOOR⁶, —(CH₂)ₙOCOR⁶, —(CH₂)ₙOR⁶, where R⁶ is hydrogen or a hydrocarbon group (saturated or unsaturated and linear or cyclic) comprising 1 to 10 carbons atoms, 1 to 6 carbon atoms, 1 to 4 carbon atoms, or 1 to 3 carbon atoms or 1 to 2 carbon atoms and n is 0, 1, 2, 3 or more. In other embodiments, R¹, R², R³ and R⁴ of formula (I) and R¹ and R⁴ of formula (II) may each independently be hydrogen or —(CH₂)ₙCN and n is 0, 1, 2, 3 or more. In additional instances, each of R¹, R², R³ and R⁴ of formula (I) and R¹ and R⁴ of formula (II) may be hydrogen or —(CH₂)ₙCONR⁷R⁸, where R⁷ and R⁸ are independently hydrogen or a hydrocarbon group (saturated or unsaturated and linear or cyclic) comprising 1 to 10 carbons atoms, 1 to 6 carbon atoms, 1 to 4 carbon atoms, or 1 to 3 carbon atoms and n is 0, 1, 2, 3 or more. In other examples, each of R¹, R², R³ and R⁴ of formula (I) and R¹ and R⁴ of formula (II) may independently be hydrogen, —(CH₂)ₙCOOR⁹, —(CH₂)ₙCOCOR⁹, —(CH₂)ₙOR⁹, where R⁹ is hydrogen or a halogen substituted hydrocarbon group (saturated or unsaturated and linear or cyclic) comprising 1 to 10 carbons atoms, 1 to 6 carbon atoms, 1 to 4 carbon atoms, or 1 to 3 carbon atoms and n is 0, 1, 2, 3 or more. The presence of internal halogen groups, such as Cl and Br, may assist in providing provide flame retardancy to the articles without the need to include a separate flame retardant. In other instances, each of R¹, R², R³ and R⁴ of formula (I) and R¹ and R⁴ of formula (II) may independently be hydrogen or —(CH₂)ₙR¹⁰, where R¹⁰ is Si(R¹¹)_{q}R¹² where R¹¹ is a hydrocarbon group (saturated or unsaturated and linear or cyclic) comprising 1 to 10 carbons atoms, 1 to 6 carbon atoms, 1 to 4 carbon atoms, or 1 to 3 carbon atoms, R¹² is a halogen, and n and q are each 0, 1, 2 or 3 or more. In other configurations, each of R¹, R², R³ and R⁴ of formula (I) and R¹ and R⁴ of formula (II) may independently be hydrogen, —(O═C—O—C═O)—, —(O═C—NR¹⁴—C═O), where R¹⁴ is a hydrocarbon group (saturated or unsaturated and linear or cyclic) comprising 1 to 10 carbons atoms, 1 to 6 carbon atoms, 1 to 4 carbon atoms, or 1 to 3 carbon atoms or 1 to 2 carbon atoms. In some examples, the groups of R¹, R², R³ and R⁴ of formulae (I) and (II) are independently selected from the groups listed herein and so no polar groups are present in the reactant molecule. For example, the groups can be selected such that no oxygen, nitrogen or other centers are present in the reactant molecule. As described herein, such polar groups may poison certain catalysts. Where it is desired to use reactants with polar groups, catalysts can be selected that are not poisoned by the groups present in the reactant molecules.

In some examples, the compound of formula (II) may be a derivative comprising the structure shown in formula (III)

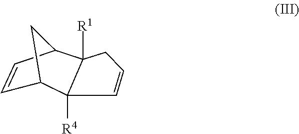

where R¹ and R⁴ of formula (III) may each independently be hydrogen or a hydrocarbon group (saturated or unsaturated and linear or cyclic) comprising 1 to 10 carbon atoms. In some embodiments, each of R¹ and R⁴ is independently hydrogen or a hydrocarbon group (saturated or unsaturated and linear or cyclic) comprising 1 to 6 carbon atoms. In other embodiments, each of R¹ and R⁴ is independently hydrogen or a hydrocarbon group (saturated or unsaturated and linear or cyclic) comprising 1 to 4 carbon atoms. In additional embodiments, each of R¹ and R⁴ is independently hydrogen or a hydrocarbon group (saturated or unsaturated and linear or cyclic) comprising 1 to 3 carbon atoms. In some embodiments, each of R¹ and R⁴ is independently hydrogen or a hydrocarbon group (saturated or unsaturated and linear or cyclic) comprising 1 or 2 carbon atoms. In further embodiments, each of R¹ and R⁴ is independently hydrogen and a methyl group. In some examples, each of R¹ and R⁴ is hydrogen to provide dicyclopentadiene. In some examples, R¹ and R⁴ of formula (III) may each independently be —(CH₂)ₙCOOR⁶, —(CH₂)ₙOCOR⁶, —(CH₂)ₙOR⁶, where R⁶ is hydrogen or a hydrocarbon group (saturated or unsaturated and linear or cyclic) comprising 1 to 10 carbons atoms, 1 to 6 carbon atoms, 1 to 4 carbon atoms, or 1 to 3 carbon atoms and n is 0, 1, 2, or 3 or more. In other embodiments, R¹ and R⁴ of formula (III) may each independently be hydrogen or —(CH₂)ₙCN where n is 0, 1, 2, 3 or more. In additional instances, R¹ and R⁴ of formula (III) may be hydrogen or —(CH₂)ₙCONR⁷R⁸, where R⁷ and R⁸ are independently hydrogen or a hydrocarbon group (saturated or unsaturated and linear or cyclic) comprising 1 to 10 carbons atoms, 1 to 6 carbon atoms, 1 to 4 carbon atoms, or 1 to 3 carbon atoms or 1 to 2 carbon atoms and n is 0, 1, 2 or 3 or more. In other examples, R¹ and R⁴ of formula (III) may independently be hydrogen, —(CH₂)ₙCOOR⁹, —(CH₂)ₙCOCOR⁹, —(CH₂)ₙOR⁹, where R⁹ is hydrogen or a halogen substituted hydrocarbon group (saturated or unsaturated and linear or cyclic) comprising 1 to 10 carbons atoms, 1 to 6 carbon atoms, 1 to 4 carbon atoms, or 1 to 3 carbon atoms or 1 to carbon atoms and n is 0, 1, 2, 3 or more. In other instances, R¹ and R⁴ of formula (III) may each independently be hydrogen or —(CH₂)ₙR¹⁰, where R¹⁰ is Si(R¹¹)_{q}R¹² where R¹¹ is a hydrocarbon group (saturated or unsaturated and linear or cyclic) comprising 1 to 10 carbons atoms, 1 to 6 carbon atoms, 1 to 4 carbon atoms, or 1 to 3 carbon atoms, R¹² is a halogen, and each of n and q is independently 0, 1, 2 or 3 or more. In other configurations, R¹ and R⁴ of formula (III) may independently be hydrogen, —(O═C—O—C═O)—, —(O═C—NR¹⁴—C═O), where R¹⁴ is a hydrocarbon group (saturated or unsaturated and linear or cyclic) comprising 1 to 10 carbons atoms, 1 to 6 carbon atoms, 1 to 4 carbon atoms, or 1 to 3 carbon atoms. In some examples, the groups of R¹ and R⁴ of formula (III) may independently be selected from the groups listed herein and so no polar groups, e.g., oxygen or nitrogen, are present in the reactant molecule.

In certain embodiments, the resins described herein may be produced by reacting two compounds having formula (I) with each other in the presence of a catalyst. The compounds of formula (I) may be the same or may be different. Similarly, two or more different or similar compounds having the general formula of formula (II) may be mixed together and polymerized by ROMP. Additionally, two or more different or similar compounds having the general formula of formula (III) may be mixed together and polymerized by ROMP. In other embodiments, one reactant is a compound of formula (I) and the other reactant is a compound of formula (II). In further instances, one reactant is a compound of formula (I) and the other reactant is a compound of formula (III). In other reactions, the one reactant is a compound of formula (II) and the other reactant is a compound of formula (III). The binary mixtures may further comprise a catalyst, solvents, rate limiters or controllers or other additives or compounds as desired. For example, as described herein, it may be desirable to cure the resins at two different temperatures, and a rate controller may be present such that polymerization does not complete at the first temperature. Where different compounds are present in a binary mixture of reactants, the compounds may be present in a 50/50 mixture (50% by weight/50% by weight), 40/60 mixture, 30/70 mixture, 20/80 mixture, 10/90 mixture, 5/95 mixture or other suitable ratios between these illustrative ratios. In some embodiments, one of the compounds of the binary mixture is either norbornene or dicylopentadiene and the other compound is independently selected from compounds of formulae (I)-(III). In some instances, polymerization may be permitted to occur for some period in the presence of a first compound and a second, different compound may be added after the first period to permit polymerization in the presence of the second compound.

In certain embodiments, the resins described herein may be produced by reacting three compounds having formulae (I), (II) and (III) with each other in the presence of a catalyst. For example, three different compounds all having a formula of formula (I) can be combined to provide a ternary mixture and polymerized using ROMP. In other instances, two compounds of formula (I) may be reacted with a compound of formula (II). In additional instances, two compounds of formula (I) may be reacted with a compound of formula (III). In other instances, one compound of formula (I) is reacted with two compounds of formula (II). In further examples, one compound of formula (I) is reacted with two compounds of formula (III). In additional examples, three compounds of formula (III) are reacted with each other and polymerized by ROMP. In other configurations, two compounds of formula (II) are reacted with one compound of formula (III). In further instances, three compounds of formula (III) are reacted with each other and polymerized by ROMP. In additional instances, a compound of formula (I) is reacted with one compound of formula (II) and another compound of formula (III). Where ternary mixtures of reactants are used, the ternary mixtures may further comprise a catalyst, solvents, rate limiters or controllers or other additives or compounds as desired. Where different compounds are present in a ternary mixture of reactants, the compounds may be present in a (⅓)/(⅓)/(⅓) mixture (33.33% by weight of each compound), a 40/40/20 mixtures, a 50/30/20 mixture, a 60/20/20 mixture, a 70/10/20 mixture, a 75/5/20 mixture, a 50/40/10 mixture, a 55/40/5 mixture, a 60/30/10 mixture, a 80/10/10 mixture, a 90/5/5/mixture a 95/2.5/2.5 mixture, a 95/4/1 mixture or other illustrative weight percentage ratios between these illustrative ratios. In some embodiments, one of the compounds of the ternary mixture is either norbornene or dicylopentadiene and the other two compounds are independently selected from compounds of formulae (I)-(III).

In certain examples, specific norbornene compounds and derivatives suitable for use include, but are not limited to, norbornene, dicyclopentadiene, 5-methyl-2-norbonene, 5-ethyl-2-norbornene, 5-ethylene-2-norbornene, 5-propyl-2-norbonene, 5-butyl-2-norbonene, 5-pentanyl-2-norbonene, 5-hexyl-2-norbonene, 5-cyclohexyl-2-norbonene, 5-septyl-2-norbonene, 5-octyl-2-norbonene, 5-nonyl-2-norbonene, 5-decyl-2-norbonene, 5-ethylene-5-chloro-2-norbornene, 5-propyl-5-chloro-2-norbonene, 5-butyl-5-chloro-2-norbonene, 5-pentanyl-5-chloro-2-norbonene, 5-hexyl-5-chloro-2-norbonene, 5-cyclohexyl-5-chloro-2-norbonene, 5-septyl-5-chloro-2-norbonene, 5-octyl-5-chloro-2-norbonene, 5-nonyl-5-chloro-2-norbonene, 5-decyl-5-chloro-2-norbonene, 5-methyl-5-bromo-2-norbornene, 5-ethylene-5-bromo-2-norbornene, 5-propyl-5-bromo-2-norbonene, 5-butyl-5-bromo-2-norbonene, 5-pentanyl-5-bromo-2-norbonene, 5-hexyl-5-bromo-2-norbonene, 5-cyclohexyl-5-bromo-2-norbonene, 5-septyl-5-bromo-2-norbonene, 5-octyl-5-bromo-2-norbonene, 5-nonyl-5-bromo-2-norbonene, 5-decyl-5-bromo-2-norbonene, methyl 5-norbornene-2-carboxylate, ethyl 5-norbornene-2-carboxylate, phenyl 5-norbornene-2-carboxylate, methyl 2-methyl-5-norbornene-2-carboxylate, butyl 3-phenyl-5-norbornene-2-carboxylate, dimethyl 5-norbornene-2,3-dicarboxylate, cyclohexyl 5-norbornene-2-carboxylate, allyl 5-norbornene-2-carboxylate, 5-norbornene-2-yl acetate, 5-norbornene-2-nitrile, 3-methyl-5-norbornene-2-nitrile, 2,3-dimethyl-5-norbornene-2,3-dinitrile, 5-norbornene-2-carboxylic acid amide, N-methyl-5-norbornene-2-carboxylic acid amide, N,N-diethyl-5-norbornene-2-carboxylic acid amide, N,N,N′,N′-tetramethyl-5-norbornene-2,3-dicarboxylic acid diamide, 5-chloro-2-norbornene, 5-bromo-2-norbornene, 5-fluoro-2-norbornene, 5-methyl-5-chloro-2-norbornene, chloroethyl 5-norbornene-2-carboxylate, dibromopropyl 5-norbornene-2-carboxylate, dichloropropyl 5-norbornene-2-carboxylate, monochlorophenyl 5-norbornene-2-carboxylate, monobromophenyl 5-norbornene-2-carboxylate, tribromophenyl 5-norbornene-2-carboxylate, 2,3-dichloro-5-norbornene, 2-bromo-5-norbornene, 2-bromomethyl-5-norbornene, tribromobenzyl 5-norbornene-2-carboxylate, 5-norbornene-2,3-dicarboxylic anhydride, 2,3-dimethyl-5-norbornene-2,3-dicarboxylic anhydride, 5-norbornene-2,3-dicarboxylic acid imide, N-phenyl-2-methyl-5-norbornene-2,3-dicarboxylic acid imide, 2-trichlorosilyl-5-norbornene, 2-(dimethylmethoxysilyl)-5-norbornene, 2-(dimethylacetylsilyl)-5-norbornene, and 2-trimethylsilyl-5-norbornene. While many different combinations of the above specific compounds are possible, it is desirable to select a compound or compounds that provide a resulting resin (or cured article comprising the resin) with one or more of the following attributes: 1) a dielectric constant at 10 GHz (as measured by ASTM 2520) of less than or equal to 2.7, more particularly a dielectric constant of less than or equal to 2.6, 2.5 or even 2.4, (2) a loss tangent (as measured by ASTM 2520) of less than or equal 0.003, more particularly, less than or equal to 0.00275, 0.0025 or even less than or equal to 0.00225, and (3) water absorption (as measured by ASTM D570) of less than or equal to 1.5%, more particularly, less than or equal to 1.4%, 1.3%, 1.25%, 1.1%, 1% or even less than or equal to 0.75%. For example, certain of the specific compounds listed above may not provide the desired physical properties when used alone but can be polymerized with another reactant, e.g., norbornene or dicyclopentadiene, in suitable amounts to provide a resin with the desired physical performance characteristics. In some instances, one of more of the compounds of formulae (I)-(III) can be combined with either norbornene or dicyclopentadiene in an amount of about 85-95 weight percent norbornene or dicyclopentadiene with the remaining 5-15 weight percent from the other compounds of formulae (I)-(III). In some embodiments, the mixture may comprise about 85-95 weight percent norbornene with the remaining 5-15 weight percent from dicyclopentadiene. In additional instances, the mixture may comprise about 85-95 weight percent dicyclopentadiene with the remaining 5-15 weight percent from norbornene.

In some embodiments, the monomers described herein can be used in combination with other materials. For example, one or more additional materials may be present in the resins produced using the monomers described herein. Illustrative additional materials include, but are not limited to, pigments, carbon black, natural rubber, silicone rubber, urethane rubber, a urethane, a polyurethane, polyvinyl chloride, polyvinylidene chloride, polyvinyl alcohol, and their copolymers with acrylic acid or acrylic acid esters or other vinyl ester monomers, fluoropolymers, including fluoroplastics (such as PTFE, FEP, TFA, ETFE, THV, etc.) and fluoroelastomers, some other polymeric material, or blends thereof. Where fluoropolymers are present, monomers of chlorotrifluoroethylene (CTFE) and vinylidene fluoride (VF2), either as homopolymers, or as copolymers with TFE, HFP, PPVE, PMVE and ethylene or propylene can be used. Additionally, the fluoropolymer may comprise a perfluoropolymer such as homopolymers and copolymers of tetrafluoroethylene (TFE), hexafluoropropylene (HFP) and fluorovinyl ethers, including perfluoropropyl and perfluoromethyl vinyl ether.

In certain embodiments, one or more of the resins described above may be used along with a suitable substrate to provide a prepreg or cured article. While the exact properties of the resin, prepreg and cured article may differ, in some instances, the prepreg may include one or more of the following physical properties (1) a dielectric constant at 10 GHz (as measured by ASTM 2520) of less than or equal to 2.7, more particularly a dielectric constant of less than or equal to 2.6, 2.5 or even 2.4, (2) a loss tangent (as measured by ASTM 2520) of less than or equal 0.003, more particularly, less than or equal to 0.00275, 0.0025 or even less than or equal to 0.00225, and (3) water absorption (as measured by ASTM D570) of less than or equal to 1.5%, more particularly, less than or equal to 1.4%, 1.3%, 1.25%, 1.1%, 1% or even less than or equal to 0.75%. In other embodiments, the cured article desirably comprises one or more of the following physical properties: (1) a dielectric constant at 10 GHz (as measured by ASTM 2520) of less than or equal to 2.7, more particularly a dielectric constant of less than or equal to 2.6, 2.5 or even 2.4, (2) a loss tangent (as measured by ASTM 2520) of less than or equal 0.003, more particularly, less than or equal to 0.00275, 0.0025 or even less than or equal to 0.00225, and (3) water absorption (as measured by ASTM D570) of less than or equal to 1.5%, more particularly, less than or equal to 1.4%, 1.3%, 1.25%, 1.1%, 1% or even less than or equal to 0.75%.

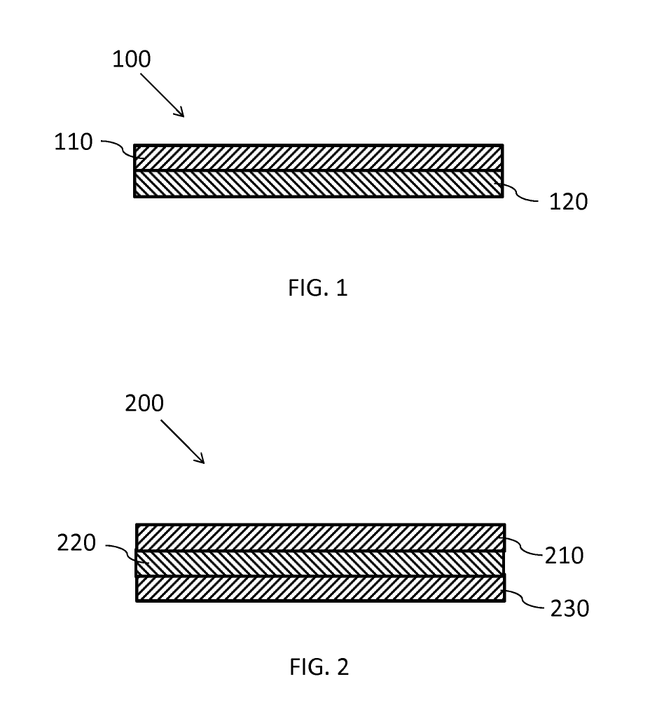

In certain embodiments and referring to FIG. 1, a prepreg 100 is shown that comprises two plies 110 and 120. Each of the plies 110, 120 may be the same or may be different. In some embodiments, at least one of the plies 110, 120 comprises a cyclically strained alkene effective to undergo ring opening metathesis polymerization in the presence of a catalyst to provide a resin. For example, one of the plies 110, 120 may include a monomer of formulae (I)-(III) in a pre-polymerized form. A catalyst may be present in combination with the cyclically strained alkene if desired. The plies 110, 120 may each comprise yarns or fiber oriented in a desired manner as described, for example, in commonly assigned U.S. Pat. No. 7,153,792, the entire disclosure of which is incorporated herein by reference. In preparing the prepreg, a cyclically strained alkene effective to undergo ROMP can be coated onto, disposed into, impregnated with or otherwise added to each of the plies 110, 120, e.g., each of the plies can be dipped into a solution or mixture comprising cyclically strained alkene. A catalyst may then be added to the plies. In other instances, the resin may first be formed and then added to the plies. For example, the resin may first be formed and each of the plies may be dipped into the resin to add the resin to the plies. Each of the plies 110, 120 may be coupled to each other by disposing one ply on the other ply, and the resulting prepreg may be cured to provide a cured article. Examples of curing processes are described in more detail below. Prior to curing, the prepreg 100 may be shaped or formed into a desired shape with a desired size, e.g., a dome shape effective to cover an antenna or communication structure. Illustrative shaping and forming methods are described herein below.

In some configurations, the article may comprise three or more plies each laid on each other and cured to provide the article. Referring to FIG. 2, a prepreg 200 comprising three plies 210, 220 and 230 is shown. The composition of the ply 220 is different from that of the plies 210 and 230. For example, the resins of the three plies 210, 220 and 230 may be the same, but the substrate present in ply 220 may be different. In other instances, the substrates in the plies 210, 220 and 230 may be the same, but the resin (or alkenes) present in the ply 220 may be different. In additional configurations, the resin and the substrate in the ply 220 may be different than that in the plies 210 and 230. In some instances, the resins and substrates present in each of the plies 210, 220 and 230 may be the same, but the thickness of the substrates or the amount of resin present may be different in one of the plies. Other configurations using three or more plies where one of the plies is physically or chemically different will be selected by the person of ordinary skill in the art, given the benefit of this disclosure.

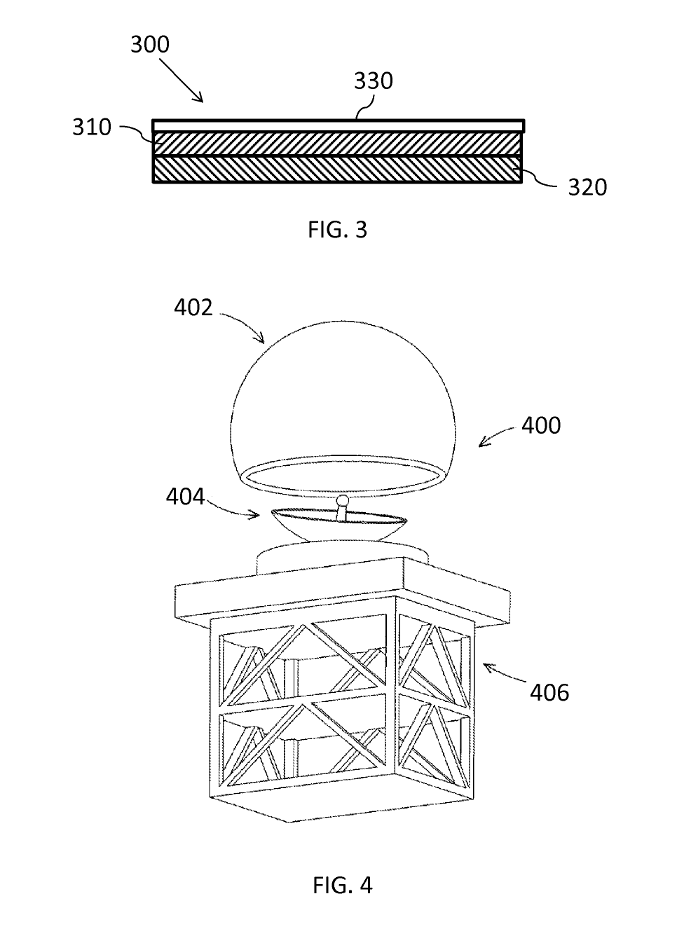

In certain instances, the prepregs may comprise one or more additional layers or materials disposed on them. For example and referring to FIG. 3, the prepreg 300 may comprise a protective covering 330 disposed on a surface of a first ply 310. The ply 310 is coupled to another ply 320. The protective covering 330 may take the form of a film, coating, a layer, a laminate or other suitable coverings that can act to protect the layers underneath the covering 330. In some embodiments, the covering may be designed to filter out wavelengths outside of a certain frequency while permitting desirable wavelengths to pass through the structure to an underlying antenna or electronic device. For example, the covering 330 may be configured as a low pass filter, a high pass filter or both to provide a transmission window permitting frequencies within the window to be transmitted through the prepreg 300. While a single covering 330 is shown, two or more coverings, layers or the like may be present. In addition, if desired, a covering may be disposed on the ply 320 such that coverings sandwich the plies within the prepreg 300. In some instances, the covering 330 may be selected for aesthetic purposes, e.g., may be camouflaged or selectively colored, but does not have any protective or functional properties. In some embodiments, the covering 330 may comprise a different material than present in the prepregs. For example, the covering may comprise ultra-high molecular weight polyethylene (UHMWPE) or fiber-reinforced UHMWPE. In other instances, the covering 330 may comprise polyetheretherketone (PEEK) or fiber-reinforced PEEK. Additional suitable covering materials different from those present in the substrates of the prepregs will be selected by the person of ordinary skill in the art, given the benefit of this disclosure.

In certain embodiments, many different substrates can be used to prepare the prepregs described herein. In some embodiments, the substrate is generally transparent to radio waves or microwaves (or another desired radiation frequency) when present in the prepreg or cured article. For example, the substrate may pass radio signals or microwave signals sent from a transmitter within the structure formed by the substrate. In addition, the substrate may permit a receiver within the structure formed by the substrate to receive radio signals or microwave signals reflected from an object or sent from a transmitter of another device or system. The cured articles are generally thin walled but structurally robust to withstand the various forces encountered by articles.

In certain examples, the substrates of the articles described herein may be porous substrates that can be impregnated with a resin produced as described herein. The substrates may be, or may comprise, a woven fabric, a non-woven fabric, a ceramic, a plastic, a glass, a polymer, or may take other forms. In some instances, the substrate may comprise fiberglass, nylon, polyester, a polyethersulfone, an aramid (such as KEVLAR® or NOMEX® available from Dupont), a polyethylene, a polypropylene, a polyolefin, a polyimide, a polyamide, a polyamide-imide, a polyphenylene sulfide, carbon, carbon black, graphite, diamond, a polybenzimidazole (PBI), a polybenzoxazole (PBO), a halocarbon or other suitable materials. In some instances, the substrate may comprise one or more forms of glass. For example, the substrate may be produced from E-glass (alumino-borosilicate glass with less than about 1 weight percent alkali oxides), A-glass (alkali-lime glass with substantially no boron oxide), E-CR-glass (alumino-lime silicate with less than 1% by weight alkali oxides), C-glass (alkali-lime glass with high boron oxide content), D-glass (borosilicate glass with a low dielectric constant), L-glass (ultra-low dispersion glass commonly used in optics), R-glass (alumino silicate glass without any substantial amounts of MgO and CaO), and S-glass (alumino silicate glass without CaO but with high MgO content).

In some instances, the substrate may be fiber free or may be fiber-reinforced to provide additional strength. Where fibers are present, the fibers may be thermoplastic fibers, thermoset fibers, glass fibers, ceramic fibers, metal fibers or other suitable types of fibers. For example, one or more glass fibers selected from E-glass fibers, A-glass fibers, E-CR-glass fibers, C-glass fibers, D-glass fibers, R-glass fibers and S-glass fibers can be used in the substrate. The substrate may include a first material, e.g., a fabric, and a second different material, e.g., glass fibers, if desired. The different materials may be present as separate plies of a multi-ply prepreg or may be present in regions or zones or the same ply. In some embodiments, the fibers may be added directly to the resins described herein, e.g., a resin of formulae (I)-(III), prior to addition of the resin to the substrate. In other instances, two or more different types of fibers are present in the substrate or the final article.

In certain embodiments, the substrates described herein and/or the resins described herein may comprise one or more additives. For example, the substrate may comprise crystals, quartz, glass particles, stabilizing agents, flame retardants (halogenated flame retardants, phosphorated flame retardants, etc.), smoke suppressants, or other materials to impart one or more desired physical properties to the cured article comprising the substrate. In some instances, one or more hardeners or curing agents may be included in the substrate or resin or both to increase (or decrease) the rate at which the prepregs cure to form the final article. When cured, the prepregs generally form a hard article that is inflexible. Such hard structures are desirably suitable for protecting underlying electronic devices from damage from weather or unwanted physical contact. In other instances, however, the cured articles may be flexible, at least to some degree, after curing or may include flexible sections after curing. The flexible articles can be bent to at least some degree into a desired shape and may be held in the desired shape using suitable fasteners, e.g., bolts, screws, adhesives, rivets or other suitable fasteners.

In some embodiments, the articles described herein may comprise one or more additional layers coupled to the prepreg layers. For example, a porous, foam or honeycomb structure may be present between prepreg layers comprising the resins described herein to increase the overall thickness of the cured article without imparting too much weight. Alternatively, the foam may be present on an inner surface, e.g., near an antenna or other electronic device, to increase the overall thickness of the articles. Where such foams or other layers are present, the materials selected for the other layers desirably do not alter the physical properties of the final article, e.g., the final article still comprises one or more of (1) a dielectric constant at 10 GHz (as measured by ASTM 2520) of less than or equal to 2.7, more particularly a dielectric constant of less than or equal to 2.6, 2.5 or even 2.4, (2) a loss tangent (as measured by ASTM 2520) of less than or equal 0.003, more particularly, less than or equal to 0.00275, 0.0025 or even less than or equal to 0.00225, and (3) water absorption (as measured by ASTM D570) of less than or equal to 1.5%, more particularly, less than or equal to 1.4%, 1.3%, 1.25%, 1.1%, 1% or even less than or equal to 0.75%.

In some examples, the prepregs described herein may be cured using many different suitable methods. For example, the prepregs may be subjected to heat to polymerize the resin and harden the prepreg. The exact curing temperature used will depend on the particular cyclically strained alkene(s) selected, but illustrative curing temperatures include, but are not limited to 80° C. to about 100° C. or about 150° C. to about 200° C. In some embodiments, the cyclically strained alkenes selected for use in the resin may be bi-curable resins that are cured in two or more different temperature steps. Without wishing to be bound by any particular scientific theory, the polymerization products which result from bi-curing, e.g., curing at two different temperatures, may not be the same as the products which result from curing at a single temperature for the cure period. In some instances, the cyclically strained alkenes may be combined with a catalyst and first cured at a temperature of about 70° C. to about 110° C. for a first period. The resin may then be cured for a second period at a higher temperature, e.g., about 150-200° C. for a second period. If desired, a third curing temperature higher than the first and second may also be used. Once polymerization ceases or terminates, the resin desirably provides a dielectric constant of less than 2.7, a loss tangent of less than 0.003 and a moisture absorption of less than 1.5%. In some instances, it may be desirable to include a rate limiting compound with the resin to limit the degree of polymerization during the first curing temperature. For example, phosphines such as triphenylphosphine or other suitable rate limiters may be added to ensure that polymerization is not complete during the first curing temperature. In other instances, the bi-curing temperatures can be selected to provide a resin (or prepreg or final, cured article) whose glass transition temperature is greater than a comparable resin produced using a single curing step.

In certain examples, the prepregs described herein may be cured using suitable devices such as molding apparatus, vacuum bag devices or using other suitable methods and devices. If desired, the curing may be performed in a substantially inert environment devoid of oxygen or other gases or an inert gas, e.g., nitrogen, may be introduced into the curing apparatus if desired. In some instances, curing may simultaneously be accompanied by forming of the prepreg into a desired shape for use in an article such as, for example, a radome. For example, where the prepregs are used to form a radome, the prepregs can be formed into pieces which can be coupled to each other to form a dome or truncated sphere. Each individual piece can be molded or formed into a desired size and thickness and then coupled to other pieces to provide the radome structure. Referring to FIG. 4, a system 400 comprises a radome 402 constructed and arranged to protect an antenna 404. The antenna 404 is mounted on a support structure 406 which may include a power source and electronics (not shown) such as a controller or processor, if desired, or may be electrically coupled to a controller or processor positioned below the structure 406. In use of the system 400, the antenna 404 is covered by the radome 402 which is also supported on support structure 406. The antenna 404 could alternately be located on a building, could be ground-based, could be coupled to an aircraft, recreational vehicle, train, bus, subway, automotive vehicle or other devices which may themselves be mobile. The radome 402 comprises a suitable structure formed using one or more of the resins described herein to protect the antenna 404 from environmental elements without causing significant interference to the signals to be transmitted and received by the antenna 404. For example, the radome 402 may be produced using one or more prepregs or plies comprising one or more of the resins described herein to provide a final radome structure that has a dielectric constant at 10 GHz (as measured by ASTM 2520) of less than or equal to 2.7, more particularly a dielectric constant of less than or equal to 2.6, 2.5 or even 2.4. In some instances, the radome 402 may also have a loss tangent (as measured by ASTM 2520) of less than or equal 0.003, more particularly, less than or equal to 0.00275, 0.0025 or even less than or equal to 0.00225. In further configurations, the radome 402 may also have a water absorption (as measured by ASTM D570) of less than or equal to 1.5%, more particularly, less than or equal to 1.4%, 1.3%, 1.25%, 1.1%, 1% or even less than or equal to 0.75%. In some embodiments, the radome 402 is produced by coupling a plurality of plies to each other, where least one of the plurality of plies comprises a substrate and a cyclically strained alkene effective to undergo ring opening metathesis polymerization in the presence of a catalyst to provide a resin. In some instances, the cyclically strained alkene may be norbornene or a norbornene derivative as described in reference to formulae (I)-(III).

In certain embodiments, while an antenna within a dish is shown under the radome 402 in FIG. 4, the antenna may be part of a larger system or other electronic devices may instead be present under radomes. For example, the antenna 404 may be a high frequency radar antenna. In other instances, the antenna 404 may be a phased array or a dish (such as a parabolic dish, a split cylinder dish) and may be rotating or non-rotating. In some instances, the antenna 404 and radomes 402 may be part of a number of different types of radar system assemblies. For example, radome 402 can be used in conjunction with weather radar systems, and airport radar systems. In certain examples, instead of using a radar antenna, the system 400 could include other antennas 404, one such antenna being a satellite communication antenna. In other instances, the radome 404 may be used as part of a cellular communication system to protect underlying antennas from weather. In some embodiments, the radome may be part of a wireless communication device, e.g., an outside Wi-Fi or Bluetooth system, that can provide communication between devices. For example, the radome and Wi-Fi device may be part of a mobile communication system that permits users to access broadband communications devices through mobile devices such as cellular phones, laptops, tablets, etc. The Wi-Fi device/radome system may be mounted on a mobile vehicle or a non-mobile structure, e.g., a telephone pole, wall of a building, etc. In some embodiments, the communications system may comprise a first system configured to operate as a radar system and a second system configured to provide wireless access. For example, a single radome of an aircraft or ship may house a radar system and a Wi-Fi system to permit user's on the aircraft or ship to have wireless communication through the mobile devices and the Wi-Fi system.

In some examples, the radomes may be present on a vehicle such as an automotive vehicle, truck, bus, train, subway, plane, a ship, a submarine or the like. For example, the radome may be integrated into (or attached to) a front or rear bumper (or both) of a vehicle and protect an underlying antenna that may transmit and receive waves for proximity detection. In other instances, the radome may be part of the vehicle to send and receive communications from and to the vehicle, e.g., may be part of a cellular communication network or wireless communication system such as those found on ships, planes and trains. Where the radome is part of a ship, plane or train, it may take an aerodynamic shape to not increase drag to a substantial degree. Where the radome is present in underwater applications, e.g., on a submarine for protecting a sonar system or in an underwater communication system, the radome may be sealed to a permanent structure so a fluid tight seal is present between the radome and the structure to protect any underlying antenna or other communications devices. Where the communication devices are deployed, e.g., from a submerged vessel to a surface, the radome may be buoyant to permit it to float on the surface without the need for an external bladder or other flotation device.

The low moisture absorption of the radomes described herein permit use of the radomes in salt water and other moist environments without any substantial interference of the transmission to and from electronic devices within the radome.

In certain embodiments, the radomes described herein may be integral to an electronic device to protect the electronic device while at the same time permitting the electronic device to receive and/or send signals. For example, a cellular phone may comprise an integral radome with an embedded microantenna. If desired, the microantenna can be configured to rotate or move to increase the overall signal receiving capabilities of the phone. A touch screen can be electrically or wirelessly coupled to the cellular phone to permit the user to access the phones features. In some embodiments, the radome may be integral to a structural component of a vehicle, e.g., a bumper, emergency lights, nose cone or other components of vehicles such that the radome takes the general shape of the structural part of the vehicle.

In some embodiments, the radomes described herein may be used for military operations communications or emergency operations communications. For example, military personnel, police vehicles, emergency centers and the like may wish to use dedicated radio bands outside normal over the air scanning frequencies to communicate with each other. A conventional handheld scanner may scan frequencies from about 29 MHz to about 1.3 GHz. These frequencies are generally referred to as very high frequencies (VHF) for frequencies from 30 MHz to about 330 MHz or ultra-high frequencies (UHF) for frequencies from about 330 MHz to about 2.9 GHz. While the radomes described herein can be used in VHF and UHF bands, emergency operation communications transmitted at these frequencies may be received and heard by anyone with a hand held scanner. To avoid reception by the public, the radomes described herein can be used in combination with a transmitter/receiver to transmit or receive signals in the S band (2-4 GHz), C band (4-8 GHz), X band (8-12 GHz), Kᵤ band (12-18 GHz), K band (18-26.5 GHz), Kₐ band (26.5-40 GHz), Q band (30-50 GHz), U band (40-60 GHz), V band (50-75 GHz), E band (60-90 GHz), W band (75-110 GHz), F band (90-140 GHz) or D band (110-170 GHz). In particular, bands such as the Kₐ band and Q band can be used in satellite communications. For example, a satellite may include a radome and underlying transmitter/receiver configured to transmit/receive signals in the 20-50 GHz range. In addition, frequencies of 20-50 GHz may be used in nose cone radar systems (or radar systems positioned other than in the nose) of aircraft for close-range targeting of targets. If desired, the geometry of the radome on aircraft may be constructed to provide stealth like capability, e.g., the radome does not comprise a shape at any portion that would readily reflect radar waves and permit detection of the aircraft by enemy personnel. The satellites may take the form of communication satellites, e.g., those with geostationary orbits, elliptical orbits or other orbits, or other types of satellites or similar devices, e.g., weather satellites, military satellites, astronomical satellites, navigational satellites, reconnaissance satellites, earth observation satellites, on space stations or other devices that orbit the earth. In other instances, the resins and articles described herein can be used to cover sonar systems, e.g., those used by the Navy that typically are designed to detect low frequencies in the 100-500 Hz or 1 kHz-10 kHz range. The sonar systems may be fixed, e.g., positioned on the ocean floor, or may be part of a vessel such as a ship or submarine.

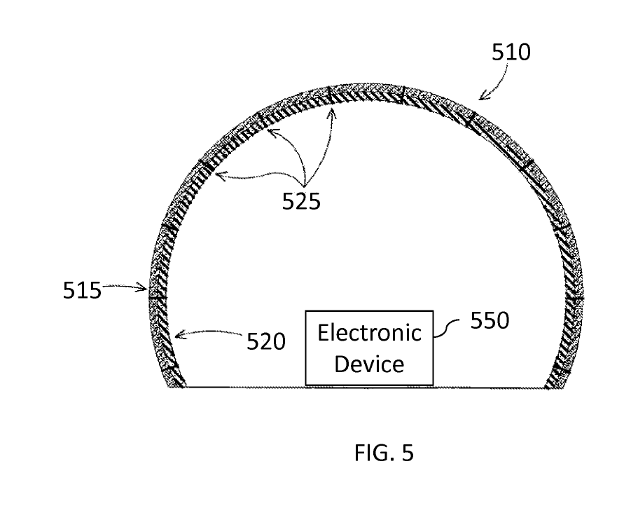

In certain examples and referring to FIG. 5, a side view of a radome 510 covering an electronic device 550 is shown. The radome 510 comprises a plurality of plies 515 as described herein. The radome may comprise an inner insulation layer 520, if desired, to insulate the electronic device 550 from the elements or to prevent thermal loss from inside the radome where an air conditioner (not shown) provides cooled air to any electronic devices within the radome 510. The radome 510 may also comprise structural support elements 525 integrally connecting sections of the radome 510. While the exact thickness of the radome 510 may vary depending on the intended use of the radome 510, in some instances, the thickness is about 0.01 inches thick to about 0.5 inches thick, more particularly about 0.01 inches to about 0.2 inches, for example, about 0.07 inches to about 0.15 inches. The electronic device 550 may take many forms as described herein and may include an antenna or transmitter/receiver that can send and receive signals. In some embodiments, the electronic device 550 may be part of a radar system, a sonar system, a communications system, e.g., Wi-Fi systems, Bluetooth systems, radio systems, cellular communication systems, satellite systems or other suitable systems.

In some embodiments, the prepregs and resins described herein may be used to construct thin-plate radomes. While the exact configuration may vary, a thin plate radome is thin in comparison with the wavelength at the operating frequency. In other instances, the radome may be constructed as a half-wavelength radome, where the radome has a thickness equivalent of about one-half the wavelength. Other variations such as quarter-wavelength radomes and the like may also be produced using the materials and prepregs described herein.

The following paragraphs, numbered consecutively from 1 through 81 provide for various embodiments described herein.

1. A radome comprising a plurality of plies coupled to each other, in which at least one of the plurality of plies comprises a substrate and a resin produced from a cyclically strained alkene effective to undergo ring opening metathesis polymerization in the presence of a catalyst to provide the resin, in which the radome comprises a dielectric constant of less than 2.7, a loss tangent of less than 0.003 and a moisture absorption of less than 1.5%.

2. The radome of paragraph 1, in which the radome comprises a dielectric constant of less than 2.7, a loss tangent of less than 0.003 and a moisture absorption of less than 1%.

3. The radome of paragraph 1, in which the radome comprises a dielectric constant of less than 2.6, a loss tangent of less than 0.0025 and a moisture absorption of less than 1%.

4. The radome of paragraph 2, in which the cyclically strained alkene is a compound of formula (I)

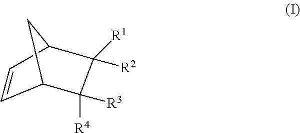

in which R¹, R², R³ and R⁴ of formula (I) may each independently be hydrogen or a hydrocarbon group comprising 1 to 10 carbon atoms.

5. The radome of paragraph 4, in which R¹, R², R³ and R⁴ of formula (I) may each independently be hydrogen or a hydrocarbon group comprising 1 to 6 carbon atoms.

6. The radome of paragraph 5, in which each of R¹, R², R³ and R⁴ of formula (I) is hydrogen.

7. The radome of paragraph 2, in which the cyclically strained alkene is a compound of formula (II)

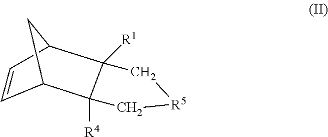

in which R¹ and R⁴ of formula (II) may each independently be hydrogen or a hydrocarbon group comprising 1 to 10 carbon atoms and R⁵ may be —CH₂, oxygen, a secondary amine or a tertiary amine.

8. The radome of paragraph 7, in which R¹ and R⁴ of formula (II) may each independently be hydrogen or a hydrocarbon group comprising 1 to 6 carbon atoms and R⁵ may be —CH₂, oxygen, a secondary amine or a tertiary amine.

9. The radome of paragraph 8, in which each of R¹ and R⁴ of formula (II) is hydrogen and R⁵ is —CH₂.

10. The radome of paragraph 2, in which the cyclically strained alkene is a compound of formula (III)

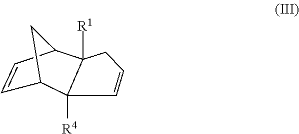

in which R¹ and R⁴ of formula (III) may each independently be hydrogen or a hydrocarbon group comprising 1 to 10 carbon atoms.

11. The radome of paragraph 10, in which R¹ and R⁴ of formula (III) may each independently be hydrogen or a hydrocarbon group comprising 1 to 6 carbon atoms.

12. The radome of paragraph 11, in which each of R¹ and R⁴ of formula (III) is hydrogen.

13. The radome of paragraph 11, in which one of R¹ and R⁴ is a halohydrocarbon group comprising 1 to 6 carbon atoms.

14. The radome of paragraph 1, in which the resin comprises two different cyclically strained alkenes each effective to undergo ring opening metathesis polymerization in the presence of a catalyst to provide the resin.

15. The radome of paragraph 14, in which one of the cyclically strained alkenes is a norbornene derivative and the other cyclically strained alkene is dicyclopentadiene.

16. The radome of paragraph 14, in which one of the cyclically strained alkenes is a 5-ethylene-2-norbornene and the other cyclically strained alkene is dicyclopentadiene.

17. The radome of paragraph 1, in which the cyclically strained alkene is effective to polymerize by ring opening metathesis polymerization in the presence of a catalyst to provide a bi-curable resin comprising a dielectric constant of less than 2.7, a loss tangent of less than 0.003 and a moisture absorption of less than 1.5%.

18. The radome of paragraph 1, in which the cyclically strained alkene is a dicylopentadiene and the substrate comprises fiberglass comprising quartz.

19. The radome of paragraph 1, in which the cyclically strained alkene is a norbornene derivative and the substrate comprises fiberglass comprising quartz.

20. The radome of paragraph 14, in which one of the cyclically strained alkenes is dicylopentadiene and the other cyclically strained alkene is a norbornene derivative and the substrate comprises fiberglass comprising quartz.

21. A prepreg comprising a plurality of plies coupled to each other, in which at least one of the plurality of plies comprises a substrate and a cyclically strained alkene effective to polymerize by ring opening metathesis polymerization in the presence of a catalyst to provide a resin, in which the resin comprises a dielectric constant of less than 2.7, a loss tangent of less than 0.003 and a moisture absorption of less than 1.5%.

22. The prepreg of paragraph 21, in which the resin comprises a dielectric constant of less than 2.6, a loss tangent of less than 0.003 and a moisture absorption of less than 1%.

23. The prepreg of paragraph 22, in which the resin comprises a dielectric constant of less than 2.4, a loss tangent of less than 0.0015 and a moisture absorption of less than 1%.

24. The prepreg of paragraph 22, in which the cyclically strained alkene is a compound of formula (I)

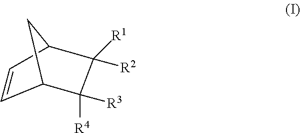

in which R¹, R², R³ and R⁴ of formula (I) may each independently be hydrogen or a hydrocarbon group comprising 1 to 10 carbon atoms.

25. The prepreg of paragraph 24, in which R¹, R², R³ and R⁴ of formula (I) may each independently be hydrogen or a hydrocarbon group comprising 1 to 6 carbon atoms.

26. The prepreg of paragraph 25, in which each of R¹, R², R³ and R⁴ of formula (I) is hydrogen.

27. The prepreg of paragraph 22, in which the cyclically strained alkene is a compound of formula (II)

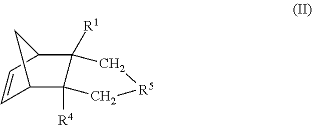

in which R¹ and R⁴ of formula (II) may each independently be hydrogen or a hydrocarbon group comprising 1 to 10 carbon atoms and R⁵ may be —CH₂, oxygen, a secondary amine or a tertiary amine.

28. The prepreg of paragraph 27, in which R¹ and R⁴ of formula (II) may each independently be hydrogen or a hydrocarbon group comprising 1 to 6 carbon atoms and R⁵ may be —CH₂, oxygen, a secondary amine or a tertiary amine.

29. The prepreg of paragraph 28, in which each of R¹ and R⁴ of formula (II) is hydrogen and R⁵ is —CH₂.

30. The prepreg of paragraph 22, in which the cyclically strained alkene is a compound of formula (III)

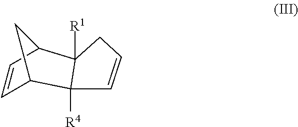

in which R¹ and R⁴ of formula (III) may each independently be hydrogen or a hydrocarbon group comprising 1 to 10 carbon atoms.

31. The prepreg of paragraph 30, in which R¹ and R⁴ of formula (III) may each independently be hydrogen or a hydrocarbon group comprising 1 to 6 carbon atoms.

32. The prepreg of paragraph 31, in which each of R¹ and R⁴ of formula (III) is hydrogen.

33. The prepreg of paragraph 31, in which one of R¹ and R⁴ is a halohydrocarbon group comprising 1 to 6 carbon atoms.

34. The prepreg of paragraph 21, in which the resin comprises two different cyclically strained alkenes each effective to undergo ring opening metathesis polymerization in the presence of a catalyst to provide the resin.

35. The prepreg of paragraph 34, in which one of the cyclically strained alkenes is a norbornene derivative and the other cyclically strained alkene is dicyclopentadiene.

36. The prepreg of paragraph 34, in which one of the cyclically strained alkenes is a 5-ethylene-2-norbornene and the other cyclically strained alkene is dicyclopentadiene.

37. The prepreg of paragraph 21, in which the cyclically strained alkene is effective to polymerize by ring opening metathesis polymerization in the presence of a catalyst to provide a bi-curable resin comprising a dielectric constant of less than 2.7, a loss tangent of less than 0.003 and a moisture absorption of less than 1.5%.

38. The prepreg of paragraph 21, in which the cyclically strained alkene is a dicylopentadiene and the substrate comprises fiberglass comprising quartz.

39. The prepreg of paragraph 21, in which the cyclically strained alkene is a norbornene derivative and the substrate comprises fiberglass comprising quartz.

40. The prepreg of paragraph 34, in which one of the cyclically strained alkenes is dicylopentadiene and the other cyclically strained alkene is a norbornene derivative and the substrate comprises fiberglass comprising quartz.

41. A resin comprising a cyclically strained alkene effective to undergo ring opening metathesis polymerization in the presence of a catalyst to provide a polymeric resin with a dielectric constant of less than 2.7, a loss tangent of less than 0.003 and a moisture absorption of less than 1.5%.

42. The resin of paragraph 41, in which the cyclically strained alkene is a compound of formula (I)

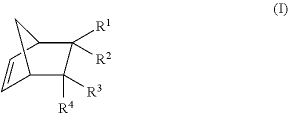

in which R¹, R², R³ and R⁴ of formula (I) may each independently be hydrogen or a hydrocarbon group comprising 1 to 10 carbon atoms.

43. The resin of paragraph 42, in which R¹, R², R³ and R⁴ of formula (I) may each independently be hydrogen or a hydrocarbon group comprising 1 to 6 carbon atoms.

44. The resin of paragraph 43, in which each of R¹, R², R³ and R⁴ of formula (I) is hydrogen.

45. The resin of paragraph 41, in which the cyclically strained alkene is a compound of formula (II)

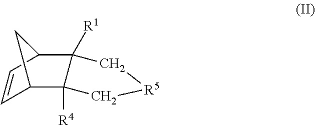

in which R¹ and R⁴ of formula (II) may each independently be hydrogen or a hydrocarbon group comprising 1 to 10 carbon atoms and R⁵ may be —CH₂, oxygen, a secondary amine or a tertiary amine.

46. The resin of paragraph 45, in which R¹ and R⁴ of formula (II) may each independently be hydrogen or a hydrocarbon group comprising 1 to 6 carbon atoms and R⁵ may be —CH₂, oxygen, a secondary amine or a tertiary amine.

47. The resin of paragraph 46, in which each of R¹ and R⁴ of formula (II) is hydrogen and R⁵ is —CH₂.

48. The resin of paragraph 41, in which the cyclically strained alkene is a compound of formula (III)

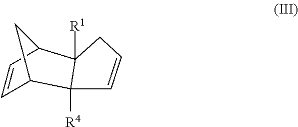

in which R¹ and R⁴ of formula (III) may each independently be hydrogen or a hydrocarbon group comprising 1 to 10 carbon atoms.

49. The resin of paragraph 48, in which R¹ and R⁴ of formula (III) may each independently be hydrogen, a hydrocarbon group comprising 1 to 6 carbon atoms or a halohydrocarbon group comprising 1 to 6 carbon atoms.

50. The resin of paragraph 41, in which the cyclically strained alkene is dicyclopentadiene.

51. A resin comprising a polymer produced from two different cyclically strained alkenes each effective to undergo ring opening metathesis polymerization in the presence of a catalyst to provide a resin with a dielectric constant of less than 2.7, a loss tangent of less than 0.003 and a moisture absorption of less than 1.5%.

52. The resin of paragraph 51, in which each of the two different cyclically strained alkenes is independently a compound of formula (I)

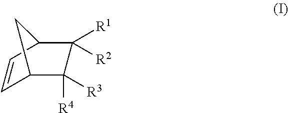

in which R¹, R², R³ and R⁴ of formula (I) may each independently be hydrogen or a hydrocarbon group comprising 1 to 10 carbon atoms.

53. The resin of paragraph 52, in which R¹, R², R³ and R⁴ of formula (I) for each cyclically strained alkene may each independently be hydrogen or a hydrocarbon group comprising 1 to 6 carbon atoms.

54. The resin of paragraph 53, in which each of R¹, R², R³ and R⁴ of formula (I) for one of the monomers is hydrogen.

55. The resin of paragraph 51, in which each of the two different cyclically strained alkenes is independently a compound of formula (II)

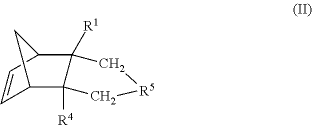

in which R¹ and R⁴ of formula (II) may each independently be hydrogen or a hydrocarbon group comprising 1 to 10 carbon atoms and R⁵ may be —CH₂, oxygen, a secondary amine or a tertiary amine.

56. The resin of paragraph 55, in which R¹ and R⁴ of formula (II) for each cyclically strained alkene may each independently be hydrogen or a hydrocarbon group comprising 1 to 6 carbon atoms and R⁵ may be —CH₂, oxygen, a secondary amine or a tertiary amine.

57. The resin of paragraph 56, in which each of R¹ and R⁴ of formula (II) for one of the cyclically strained alkenes is hydrogen and R⁵ is —CH₂.

58. The resin of paragraph 51, in which the each of the cyclically strained alkenes is independently a compound of formula (III)

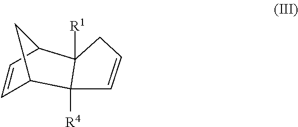

in which R¹ and R⁴ of formula (III) may each independently be hydrogen or a hydrocarbon group comprising 1 to 10 carbon atoms.

59. The resin of paragraph 58, in which R¹ and R⁴ of formula (III) for each cyclically strained alkene may each independently be hydrogen, a hydrocarbon group comprising 1 to 6 carbon atoms or a halohydrocarbon group comprising 1 to 6 carbon atoms.

60. The resin of paragraph 51, in which one of the cyclically strained alkenes is a norbornene derivative and the other cyclically strained alkene is dicyclopentadiene.

61. A system comprising:

the radome of any of paragraphs 1-20; and

an electronic device covered by the radome.

62. The system of paragraph 61, in which the electronic device comprises an antenna.

63. The system of paragraph 61, in which the radome is sized and arranged to be placed on an aircraft.

64. The system of paragraph 61, in which the radome is sized and arranged to be placed on a ship.

65. The system of paragraph 61, in which the radome is sized and arranged to be placed on a hull of a ship, in which the radome is immersed in the water during operation of the ship.

66. The system of paragraph 61, in which the electronic device is part of a radar system.

67. The system of paragraph 61, in which the electronic device is part of a sonar system.

68. The system of paragraph 61, in which the electronic device is part of a communication system.

69. The system of paragraph 68, in which the communication is selected from the group consisting of Wi-Fi systems, Bluetooth systems, radio systems, cellular communication systems and satellite systems.

70. A satellite comprising a transmitter/receiver and the radome of any of paragraphs 1-20 sized and arranged to protect the transmitter/receiver.

71. An automotive vehicle comprising a transmitter/receiver configured to couple to a bumper of the vehicle, the vehicle further comprises the radome of any of paragraphs 1-20 sized and arranged to protect the coupled transmitter/receiver.

72. An aircraft comprising a radar system and the radome of any of paragraphs 1-20 configured to cover and protect the radar system.

73. The aircraft of paragraph 72, in which the radar system is positioned in a nose cone or an undersurface of the aircraft.

74. A ship comprising a radar system and the radome of any of paragraphs 1-20 configured to cover and protect the radar system.

75. The ship of paragraph 74, in which radar system is positioned external to the hull of the ship and beneath the water surface in operation of the ship.

76. A submarine comprising a sonar system and the radome of any of paragraphs 1-20 configured to cover and protect the sonar system.

77. The submarine of paragraph 76, in which the sonar system is positioned external to the hull of the submarine.

78. A method of producing a radome comprising:

disposing the resin of any of paragraphs 41-60 on a substrate; and

polymerizing the disposed resin to provide a radome comprising a dielectric constant of less than 2.7, a loss tangent of less than 0.003 and a moisture absorption of less than 1.5%.

79. The method of paragraph 78, in which the polymerizing step comprises permitting the resin to polymerize by ring opening metathesis polymerization at a first temperature for a first period and then completing polymerization of the resin at a second temperature, higher than the first temperature, for a second period.

80. The method of paragraph 79, further comprising adding at least one additive to the resin before or after polymerization of the resin.

81. The method of paragraph 79, in which the additive is a flame retardant, a smoke suppressant or a pigment.

Certain specific examples were described below to illustrate some of the novel aspects and features of the technology described herein.

### Materials of Examples

Dicyclopentadiene (DCPD), 5-ethylene-2-norbornene (EN), triphenylphosphine, and ruthenium catalyst (Grubbs catalyst, 1st generation) were purchased from Sigma-Aldrich. Additives, such as free radical initiator (tert-butyl peroxide) and anti-oxidant (4,4′-methylenebis(2,6-di-tert-butylphenol) were purchased from Sigma-Aldrich.

### Examples 1-2

Examples 1-2 compare the properties of a poly-dicyclopentadiene (poly-DCPD) polymer resin and a copolymer resin of DCPD and EN. Example 3 shows copolymer between DCPD and EN and additives, such as 4,4′-methylenebis(2,6-di-tert-butylphenol (for anti-oxidation) and tert-butyl peroxide for further cross-linking to increase T_{g}. The percentages shown in Table 1 for the materials are weight percentages. In a typical procedure, a mixture of DCPD and EN (total weight: 50 g) was placed in a 4 ounce glass jar, and the mixture was stirred at room temperature. To the mixture was added triphenylphosphine (0.1%; 50 mg) to control the reaction rate, and then a ruthenium catalyst (0.1 weight % of benzylidene-bis(tricyclohexylphosphine)-dichlororuthenium; 50 mg) was added to the mixture. The formulation solution was stirred for 40 minutes until all catalysts were dissolved. The resin formulation was poured into a disc shaped mold (2.5 inches diameter×⅛ inch thickness), and placed in a vacuum oven which was degased for 10 minutes at room temperature under vacuum. Then, the formulation was cured at 80° C. for 2 hours followed by post-curing at 150° C. for 1 hour.

Each resin formulation was applied to a quartz fabric (JPS Quartz 4581 with a resin content of 35 weight percent) to provide a prepreg ply. A twelve-ply laminate (6 inches by 6 inches) was laid up using the prepreg plies and cured in a vacuum bag using following two step curing (bi-curing) conditions: 80° C. for 2 hours followed by 150° C. for 1 hour.

Table 1 lists the results of certain physical measurements. The tests used were those noted above for each property measured. Glass transition temperature (T_{g}) was measured by ASTM D3418-03 though other comparable methods can be used.

TABLE 1

| | Formulation No. | | |
|---|---|---|---|
| Components | 1 | 2 | 3 |
| DCPD | 100 | 95 | 95 |
| EN | 0 | 5 | 5 |
| Triphenylphosphine | 0.1 | 0.1 | 0.1 |
| catalyst | 0.1 | 0.1 | 0.1 |
| (4,4′-methylenebis(2,6-di- | 0 | 0 | 3 |
| tert-butylphenol) | | | |
| tert-butyl peroxide | 0 | 0 | 3 |
| Properties | | | |
| Dielectric constant (1 MHz) | 2.39 | 2.34 | 2.40 |
| Dielectric constant (10 | | 2.436 (resin) | |
| GHz) | | 2.548 (laminate) | |
| Loss tangent (10 GHz) | | 0.0011 (resin) | |
| | | 0.0021 (laminate) | |
| Moisture absorption (%)^{a} | | 0.09 | |
| T_{g} (° C.) | | 110 (150.8)^{b} | 204.8^{b} |

^{a}85° C./85% RH after 12 days.
^{b}Cured at 80° C. for 2 h and 190° C. for 1 h.

The results in Table 1 show that the polymer of DCPD and the copolymer of DCPD and EN both provide a dielectric constant at 1 MHz of less than 2.4. Dielectric constant is expected to decrease even further, e.g., be less than 2.4, with increasing frequency. The loss tangent of the resin (0.0011) and the laminate (0.0021) are also below a threshold value, e.g., 0.003. Similarly, the moisture absorption (0.09) is below a threshold value, e.g., below about 1.5%. The longer cure time using the DCPD/EN resin provides a glass transition temperature above a desired temperature, e.g., about 150 degrees Celsius or above.

When introducing elements of the examples disclosed herein and the claims below, the articles “a,” “an,” “the” and “said” are intended to mean that there are one or more of the elements. The terms “comprising,” “including” and “having” are intended to be open-ended and mean that there may be additional elements other than the listed elements. Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A radome comprising a plurality of plies coupled to each other, in which at least one of the plurality of plies comprises a substrate and a resin produced from a cyclically strained alkene effective to undergo ring opening metathesis polymerization in the presence of a catalyst to provide the resin, in which the radome comprises a dielectric constant of less than 2.7, a loss tangent of less than 0.003 and a moisture absorption of less than 1.5%.

2. The radome of claim 1, in which the cyclically strained alkene is a compound of formula (I) 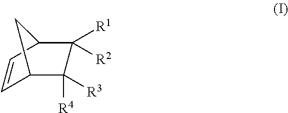
in which R¹, R², R³ and R⁴ of formula (I) may each independently be hydrogen or a hydrocarbon group comprising 1 to 10 carbon atoms.

3. The radome of claim 2, in which each of R¹, R², R³ and R⁴ of formula (I) is hydrogen.

4. The radome of claim 1, in which the cyclically strained alkene is a compound of formula (II) 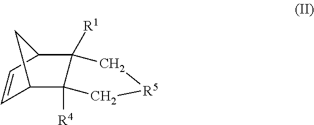
in which R¹ and R⁴ of formula (II) may each independently be hydrogen or a hydrocarbon group comprising 1 to 10 carbon atoms and R⁵ may be —CH₂, oxygen, a secondary amine or a tertiary amine.

5. The radome of claim 4, in which each of R¹ and R⁴ of formula (II) is hydrogen and R⁵ is —CH₂.

6. The radome of claim 1, in which the cyclically strained alkene is a compound of formula (III) 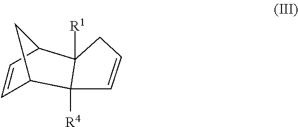
in which R¹ and R⁴ of formula (III) may each independently be hydrogen or a hydrocarbon group comprising 1 to 10 carbon atoms.

7. The radome of claim 6, in which each of R¹ and R⁴ of formula (III) is hydrogen.

8. The radome of claim 1, in which the resin comprises two different cyclically strained alkenes each effective to undergo ring opening metathesis polymerization in the presence of a catalyst to provide the resin.

9. The radome of claim 8, in which one of the cyclically strained alkenes is a norbornene derivative and the other cyclically strained alkene is dicyclopentadiene.

10. The radome of claim 8, in which one of the cyclically strained alkenes is a 5-ethylene-2-norbornene and the other cyclically strained alkene is dicyclopentadiene.

11. A prepreg comprising a plurality of plies coupled to each other, in which at least one of the plurality of plies comprises a substrate and a cyclically strained alkene effective to polymerize by ring opening metathesis polymerization in the presence of a catalyst to provide a resin, in which the resin comprises a dielectric constant of less than 2.7, a loss tangent of less than 0.003 and a moisture absorption of less than 1.5%.

12. The prepreg of claim 11, in which the cyclically strained alkene is a compound of formula (I) 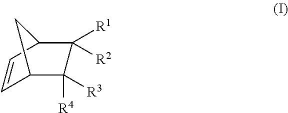
in which R¹, R², R³ and R⁴ of formula (I) may each independently be hydrogen or a hydrocarbon group comprising 1 to 10 carbon atoms.

13. The prepreg of claim 12, in which each of R¹, R², R³ and R⁴ of formula (I) is hydrogen.

14. The prepreg of claim 11, in which the cyclically strained alkene is a compound of formula (II) 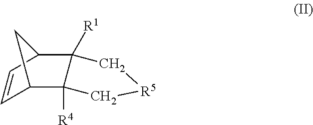
in which R¹ and R⁴ of formula (II) may each independently be hydrogen or a hydrocarbon group comprising 1 to 10 carbon atoms and R⁵ may be —CH₂, oxygen, a secondary amine or a tertiary amine.

15. The prepreg of claim 14, in which each of R¹ and R⁴ of formula (II) is hydrogen and R⁵ is —CH₂.

16. The prepreg of claim 11, in which the cyclically strained alkene is a compound of formula (III) 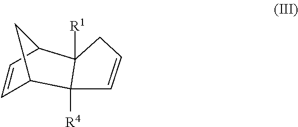
in which R¹ and R⁴ of formula (III) may each independently be hydrogen or a hydrocarbon group comprising 1 to 10 carbon atoms.

17. The prepreg of claim 16, in which each of R¹ and R⁴ of formula (III) is hydrogen.

18. The prepreg of claim 11, in which the resin comprises two different cyclically strained alkenes each effective to undergo ring opening metathesis polymerization in the presence of a catalyst to provide the resin.

19. The prepreg of claim 34, in which one of the cyclically strained alkenes is a norbornene derivative and the other cyclically strained alkene is dicyclopentadiene, or one of the cyclically strained alkenes is a 5-ethylene-2-norbornene and the other cyclically strained alkene is dicyclopentadiene.

20. A resin comprising a cyclically strained alkene effective to undergo ring opening metathesis polymerization in the presence of a catalyst to provide a polymeric resin with a dielectric constant of less than 2.7, a loss tangent of less than 0.003 and a moisture absorption of less than 1.5%, wherein the cyclically strained alkene is a compound of formula (I) 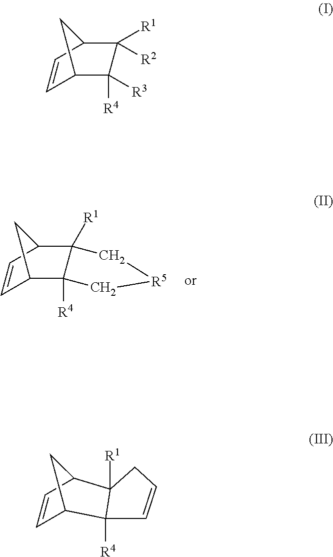
in which R¹, R², R³ and R⁴ of formula (I) may each independently be hydrogen or a hydrocarbon group comprising 1 to 10 carbon atoms, R¹ and R⁴ of formula (II) may each independently be hydrogen or a hydrocarbon group comprising 1 to 10 carbon atoms and R⁵ may be —CH₂, oxygen, a secondary amine or a tertiary amine, or R¹ and R⁴ of formula (III) may each independently be hydrogen or a hydrocarbon group comprising 1 to 10 carbon atoms or mixtures of formulae (I) through (III).
